(19) United States
(12) Patent Application Publication
(10) Pub. No.: US 2022/0262615 A1
(43) Pub. Date: Aug. 18, 2022

(54) ANALYTICAL DEVICE

(71) Applicant: SHIMADZU CORPORATION, Kyoto-shi (JP)

(72) Inventor: Shiro MIZUTANI, Kyoto-shi (JP)

(73) Assignee: SHIMADZU CORPORATION, Kyoto-shi (JP)

(21) Appl. No.: 17/737,612

(22) Filed: May 5, 2022

Related U.S. Application Data
(62) Division of application No. 17/058,321, filed on Nov. 24, 2020.

(51) Int. Cl. H01J 49/40; H01J 49/02; H01J 49/10

(52) U.S. Cl. CPC H01J 49/40; H01J 49/10; H01J 49/022

(57) ABSTRACT

An analytical device includes: a first electrode to which a pulse voltage for accelerating ions is applied; at least one switching element that controls application of the pulse voltage to the first electrode; a second electrode that defines a space in which the ions fly; an ion detector that detects the ions; and a vacuum vessel that has the second electrode inside, wherein: the switching element is in contact with an insulator, and the insulator is in contact with the vacuum vessel.

### CROSS REFERENCE TO RELATED APPLICATIONS

This application is a Divisional Application of U.S. application Ser. No. 17/058,321, filed Nov. 24, 2020, which is a National Stage of International Application No. PCT/JP2018/020355 filed May 28, 2018, the contents of all of which are incorporated herein by reference in their entirety.

### TECHNICAL FIELD

The present invention relates to an analytical device.

### BACKGROUND ART

In a time-of-flight mass spectrometer (hereinafter, appropriately referred to as TOF-MS), ions are accelerated by an electric field generated by a pulse voltage, and m/z (mass-to-charge ratio) of each ion is measured based on flight time that elapses before accelerated ions are detected by a detector. If a time when application of the pulse voltage starts or a waveform of the pulse voltage varies due to measurement conditions, measurement accuracy of the flight time will decrease. In order to perform accurate mass spectrometry, it is necessary to suppress the variation in flight time depending on the measurement conditions to about several ppm or less, so it is necessary to improve the variation due to various causes.

As a method of suppressing such variation, for example, in Patent Literature 1 (PTL 1), variation in flight time due to incomplete return of voltages of some elements when a period between applying the pulse voltages is shortened, is reduced by changing the voltage applied to each electrode constituting the TOF-MS.

### CITATION LIST

### Patent Literature

PTL 1: International publication No. 2017/122276

### SUMMARY OF INVENTION

### Technical Problem

Temperature of a switching element that controls application of a pulse voltage changes depending on a period between pulse voltages and a room temperature. When the temperature of the switching element changes, the time when application of the pulse voltage is started or the waveform of the pulse voltage change, which lowers the measurement accuracy of flight time.

### Solution to Problem

According to the 1st aspect of the present invention, an analytical device comprises: a first electrode to which a pulse voltage for accelerating ions is applied; at least one switching element that controls application of the pulse voltage to the first electrode; a second electrode that defines a space in which the ions fly; an ion detector that detects the ions; and a vacuum vessel that has the second electrode inside, wherein: the switching element is in contact with an insulator, and the insulator is in contact with the vacuum vessel.

According to the 2nd aspect of the present invention, in the analytical device according to the 1st aspect, it is preferred that thermal conductivity of the insulator at 20° C. is 2 W/(m·K) or more.

According to the 3rd aspect of the present invention, in the analytical device according to the 2nd aspect, it is preferred that the insulator comprises ceramics.

According to the 4th aspect of the present invention, in the analytical device according to the 3rd aspect, it is preferred that the insulator comprises alumina.

According to the 5th aspect of the present invention, it is preferred that the analytical device according to any one of the 1st to 4th aspects further comprises: a temperature regulation unit that regulates temperature of the vacuum vessel.

According to the 6th aspect of the present invention, in the analytical device according to any one of the 1st to 5th aspects, it is preferred that the vacuum vessel includes a mounting portion for mounting the insulator; and the mounting portion holds the at least one switching element via the insulator.

According to the 7th aspect of the present invention, in the analytical device according to any one of the 1st to 6th aspects, it is preferred that the analytical device includes at least one of a time-of-flight mass spectrometer and an electric field type Fourier transform mass spectrometer.

### Advantageous Effects of Invention

According to the present invention, it is possible to suppress variation in flight time due to temperature change of the switching element that controls application of the pulse voltage.

### BRIEF DESCRIPTION OF DRAWINGS

FIG. 1 is a conceptual diagram showing a configuration of an analytical device according to one embodiment.

FIG. 2 is a conceptual diagram showing configurations of an information processing unit and a pulse voltage application circuit.

FIG. 3 is a conceptual diagram showing a circuit configuration of the pulse voltage application circuit.

FIG. 4 is a graph schematically showing a voltage in each part of the analytical device.

FIG. 5(A) is a graph showing a waveform of a pulse voltage applied to an electrode of a first acceleration unit, FIG. 5(B) is a graph schematically showing that measured flight time varies depending on variation of waveforms of the pulse voltages, and FIG. 5(C) is a graph schematically showing that measured flight time varies depending on change in the time when application of a pulse voltage is started.

FIG. 6 is a conceptual diagram showing a mode of mounting switching elements in a variation.

### DESCRIPTION OF EMBODIMENTS

Hereinafter, embodiments for carrying out the present invention will be described with reference to the drawings.

### First Embodiment

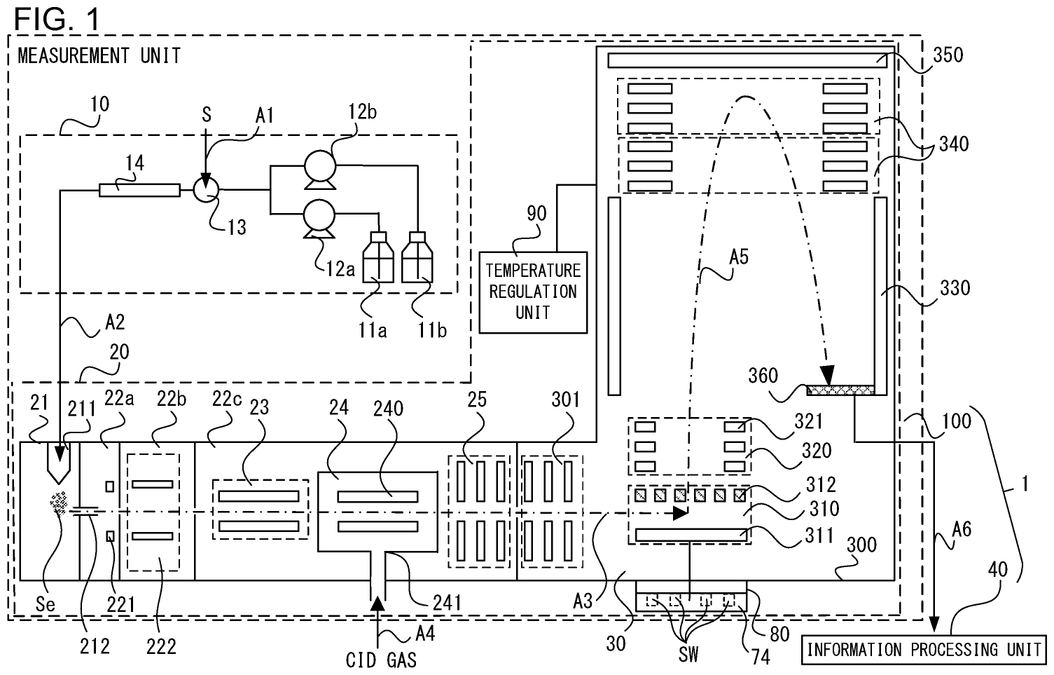

FIG. 1 is a conceptual diagram for explaining an analytical device according to the present embodiment. The analytical device 1 includes a measurement unit 100 and an information processing unit 40. The measurement unit 100 includes a liquid chromatograph 10 and a mass spectrometer 20.

The liquid chromatograph 10 includes mobile phase containers 11a and 11b, liquid feeding pumps 12a and 12b, a sample introduction unit 13, and an analytical column 14. The mass spectrometer 20 includes an ionization chamber 21 having an ionization unit 211, a first vacuum chamber 22a having an ion lens 221, a tube 212 for introducing ions from the ionization chamber 21 into the first vacuum chamber 22a, a second vacuum chamber 22b having an ion guide 222, a third vacuum chamber 22c, an analysis chamber 30, a temperature regulation unit 90, a switch unit 74, and a heat conductive portion 80. The third vacuum chamber 22c includes a first mass separation unit 23, a collision cell 24, and an ion guide 25. The collision cell 24 includes an ion guide 240 and a CID gas introduction port 241. The switch unit 74 includes switching element SW.

The analysis chamber 30 includes a vacuum vessel 300, an ion transport electrode 301, a first acceleration unit 310, a second acceleration unit 320, a flight tube 330, a reflectron electrode 340, a back plate 350, and a detection unit 360. The first acceleration unit 310 includes an pusher electrode 311 and an puller electrode 312.

The type of the liquid chromatograph (LC) 10 is not particularly limited. Each of the mobile phase containers 11a and 11b includes a container capable of storing liquid such as vial, bottle or the like, and store mobile phases having different composition, respectively. The mobile phases stored in the mobile phase containers 11a and 11b are referred to as mobile phase A and mobile phase B, respectively. The mobile phase A and the mobile phase B having been output from the liquid feed pumps 12a and 12b, respectively, are mixed on the way of the flow path and introduced into the sample introduction unit 13. The composition of the mobile phase introduced into the analytical column 14 changes with time as the liquid feed pumps 12a and 12b change the flow rates of the mobile phase A and the mobile phase B, respectively.

The sample introduction unit 13 includes a sample introduction device such as an autosampler, and introduces a sample S into the mobile phase (arrow A1). The sample S introduced by the sample introduction unit 13 passes through a guard column (not shown) as appropriate and is introduced into the analytical column 14.

The analytical column 14 has a stationary phase, and components of the introduced sample S are eluted at different retention times according to the difference in affinity of the component with the mobile phase and the stationary phase. The types of the analytical column 14 and the stationary phase are not particularly limited. The eluted sample eluted from the analytical column 14 is introduced into the ionization chamber 21 of the mass spectrometer 20 (arrow A2). It is preferable that the eluted sample in the analytical column 14 be input to the mass spectrometer 20 by online control without requiring an operation such as dispensing by a user of the analytical device 1 (hereinafter, simply referred to as “user”).

The mass spectrometer 20 performs tandem mass spectrometry on the eluted sample introduced from the analysis column 14. The path of an ionized eluted sample Se is schematically shown by the arrow A3 of long dashed short dashed line.

The ionization chamber 21 of the mass spectrometer 20 ionizes the introduced eluted sample Se. The ionization method is not particularly limited, but in the case where liquid chromatography/tandem mass spectrometry (LC/MS/MS) is performed as in the present embodiment, an electrospray method (ESI) is preferable, and in the following embodiments, it is assumed that ESI is used. The ionized eluted sample Se emitted from the ionization unit 211 moves due to pressure difference between the ionization chamber 21 and the first vacuum chamber 22a, passes through the tube 212, and enters the first vacuum chamber 22a.

A degree of vacuum is the highest in the analysis chamber 30, followed by that of the third vacuum chamber 22c, the second vacuum chamber 22b and the first vacuum chamber 22a in this order, and the analysis chamber 30 is evacuated to a pressure of, for example, 10⁻³ Pa or less. The ions that have entered the first vacuum chamber 22a pass through the ion lens 221 and are introduced into the second vacuum chamber 22b. The ions that have entered the second vacuum chamber 22b pass through the ion guide 222 and are introduced into the third vacuum chamber 22c. The ions introduced into the third vacuum chamber 22c are emitted to the first mass separation unit 23. By the time the ions enter the first mass separation unit 23, the ion lens 221, the ion guide 222, and the like converge the ions passing therethrough by electromagnetic action.

The first mass separation unit 23 includes a quadrupole mass filter, and has selectively pass through ions of set m/z as precursor ions by electromagnetic action based on a voltage applied to the quadrupole mass filter and emit toward the collision cell 24. The first mass separation unit 23 selectively passes the ionized eluted sample Se as precursor ions.

The collision cell 24 dissociates the ionized eluted sample Se by collision induced dissociation (CID) while controlling the movement of ions by the ion guide 240, to generate fragment ions. A gas containing argon, nitrogen, or the like (hereinafter referred to as CID gas) that ions collide with during CID is introduced from the CID gas introduction port 241 so as to have a predetermined pressure in the collision cell (arrow A4). Generated fragment ions are emitted toward the ion guide 25. The ions containing the fragment ions that have passed through the ion guide 25 enter the analysis chamber 30.

The ions that have entered the analysis chamber 30 pass through the ion transport electrode 301 while being controlled in movement by the ion transport electrode 301, and enter the first acceleration unit 310. The pusher electrode 311 of the first acceleration unit 310 is an acceleration electrode to which a pulse voltage having the same polarity as the polarity of ions to be detected is applied to accelerate the ions in a direction away from the pusher electrode 311. The puller electrode 312 of the first acceleration unit 310 is formed in a grid pattern so that ions can pass through the inside thereof. The puller electrode 312 is an acceleration electrode to which a pulse voltage having a polarity opposite to a polarity of ions to be detected is applied to accelerate the ions located between the pusher electrode 311 and the puller electrode 312 toward the puller electrode 312. The pusher electrode 311 and the puller electrode 312 are collectively referred to as a first acceleration electrode. The ions accelerated by the electric field generated by the pulse voltage applied to the pusher electrode 311 and the puller electrode 312 in the first acceleration unit 310 enter the second acceleration unit 320. In FIG. 1, the path of the ions accelerated by the first acceleration unit 310 is schematically shown by an arrow A5.

The second acceleration unit 320 includes a plurality of electrodes (hereinafter, referred to as second acceleration electrodes 321). Voltage of, for example, several thousand V having a polarity opposite to the polarity of ions to be detected is applied to the second acceleration electrode 321. While passing through the second acceleration unit 320, the ions are appropriately converged while being accelerated by the electric field generated by the voltage applied to these electrodes and enter the space surrounded by the flight tube 330.

The flight tube 330 includes a flight tube electrode, controls the movement of ions by a voltage applied to the flight tube electrode, and defines a space in which ions fly. Voltage of, for example, several thousand V having a polarity opposite to that of the ions to be detected is applied also to the flight tube electrode.

A voltage higher than the flight tube voltage is applied to the reflectron electrode 340 and the back plate 350 at the time of detecting positive ions, and the electric field generated by this voltage changes the traveling direction of ions. The ions whose traveling directions have been changed move along the folded orbit schematically indicated by the arrow A5 and enter the detection unit 360. It is to be noted that, at the time of detecting negative ions, a voltage lower than the flight tube voltage is applied to the reflectron electrode 340 and the back plate 350.

The detection unit 360 includes an ion detector such as a multi-channel plate and detects the ions that have entered the detection unit 360. A detection mode may be either a positive ion mode for detecting positive ions or a negative ion mode for detecting negative ions. A detection signal obtained by detecting ions is A/D converted by an A/D converter (not shown), becomes a digital signal, and is input to the information processing unit 40 (arrow A6).

The switch unit 74 switch to establishing electrical continuity between the high voltage power supply unit 75, which will be described later, and the first acceleration electrode at a set time by the switching elements SW, and applies a predetermined pulse voltage to the first acceleration electrode. As will be described in detail later, the switch unit 74 is thermally coupled to the vacuum vessel 300 by the heat conductive portion 80, and thereby the temperature change of the switching elements SW is suppressed.

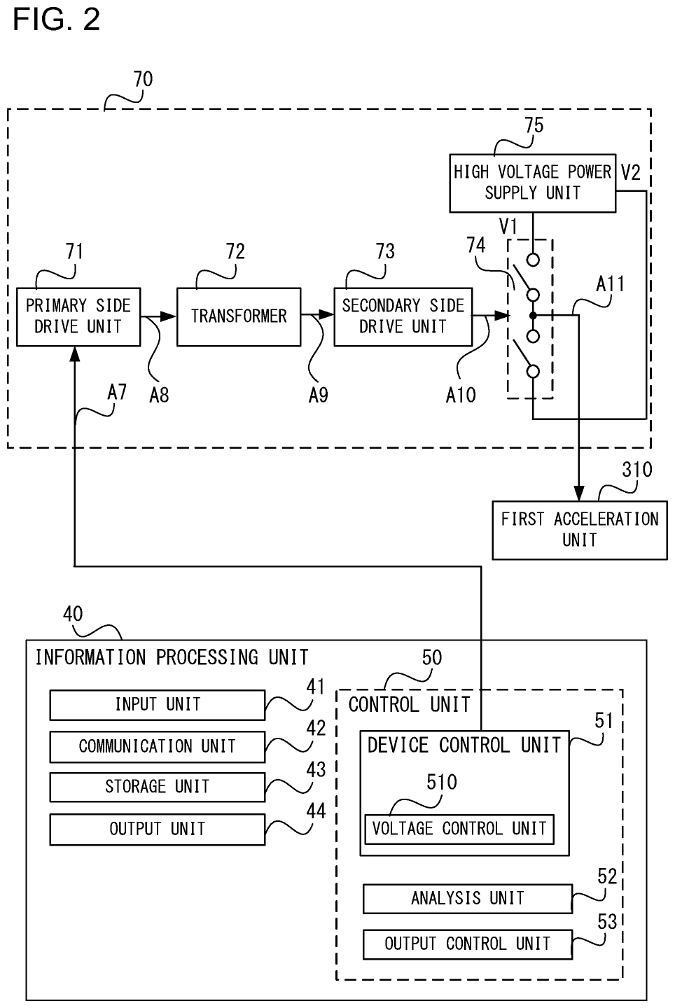

FIG. 2 is a conceptual diagram showing configurations of the information processing unit 40 and a circuit for applying a pulse voltage (hereinafter, referred to as a pulse voltage application circuit). The pulse voltage application circuit 70 includes a primary side drive unit 71, a transformer 72, a secondary side drive unit 73, the switch unit 74, and the high voltage power supply unit 75. In FIG. 2, flow of the control signal from a device control unit 51 is schematically shown by arrows A7 to A10. Further, it is schematically indicated by the arrow A11 that the pulse voltage is applied from the switch unit 74 to the first acceleration electrode of the first acceleration unit 310.

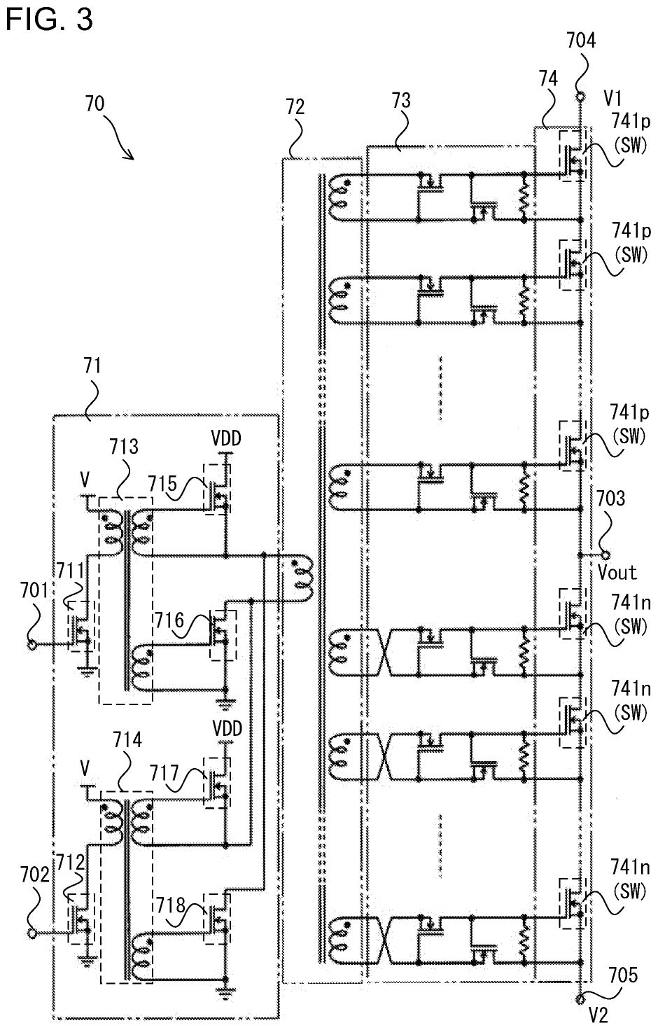

The primary side drive unit 71 supplies a drive current to a primary winding of the transformer 72 based on a control signal from a voltage control unit 510 of the control unit 50 described later, and thereby the control signal is transmitted to the secondary side drive unit 73 via the transformer 72. Voltage V and voltage VDD are applied to a plurality of terminals of the primary side drive unit 71 from a power supply (not shown), respectively (see FIG. 3). The transformer 72 includes the primary winding and a secondary winding, made of a high voltage insulated wire, and generates a voltage across the secondary winding based on a drive current passing through the primary winding. Thereby, the transformer 72 transmits the control signal from the primary side drive unit 71 to the secondary side drive unit 73 while insulating the primary side drive unit 71 from the secondary side drive unit 73.

The secondary side drive unit 73 transmits the control signal to the switching elements SW of the switch unit 74. The switch unit 74 switches electrical connection between the high voltage power supply unit 75 and the first acceleration unit 310 on and off based on a switching characteristic of the switching elements SW. This switching characteristic is a characteristic of a parameter related to switching of the electrical connection with respect to an input to the switching elements SW. For example, in a MOSFET, it is a characteristic of conductance between a source and a drain with respect to a gate voltage. The high voltage power supply unit 75 includes a DC voltage source having two output ends that output two voltages V1 and V2. The switch unit 74 switches from one of these output ends to the other to be electrically connected to the first acceleration electrode of the first acceleration unit 310 for a time period corresponding to the pulse width (several μs to several tens of μs, etc.) so that the high-voltage power supply unit 75 applies a pulse voltage to the first acceleration unit 310. The wave height of the pulse voltage (corresponding to the difference between V1 and V2) is appropriately set to several thousand V or the like. The high voltage power supply unit 75 may be provided with two DC voltage sources capable of outputting each of the two voltages V1 and V2, or in the case where either V1 or V2 is set to the ground potential (0 [V]), it may be configured to connect the output end of the ground potential to the ground electrode.

FIG. 3 is a circuit configuration diagram of the pulse voltage application circuit 70 including the primary side drive unit 71, the transformer 72, the secondary side drive unit 73, and the switch unit 74. The primary side drive unit 71 includes MOSFETs 711, 712, 715 to 718, and primary side transformers 713 and 714. The switch unit 74 includes MOSFETs 741p and 741n, which are switching elements SW. The MOSFETs 741p and the MOSFETs 741n are arranged so that when the voltage is induced to the secondary side by the transformer 72, the voltage having the opposite polarity is induced as the gate voltage. When switching, the switch unit 74 connects the first acceleration electrode to either the positive electrode side output end 704 (voltage V1) or the negative electrode side output end 705 (voltage V2) of the high voltage power supply unit 75 based on the gate voltages of the MOSFETs 741p and 741n. Hereinafter, it will be briefly described that a pulse voltage (wave height 2500V (V1=2500 [V], V2=0 [V])) is applied to the pusher electrode 311 based on the control signal from the voltage control unit 510. For details, refer to Patent Literature 1.

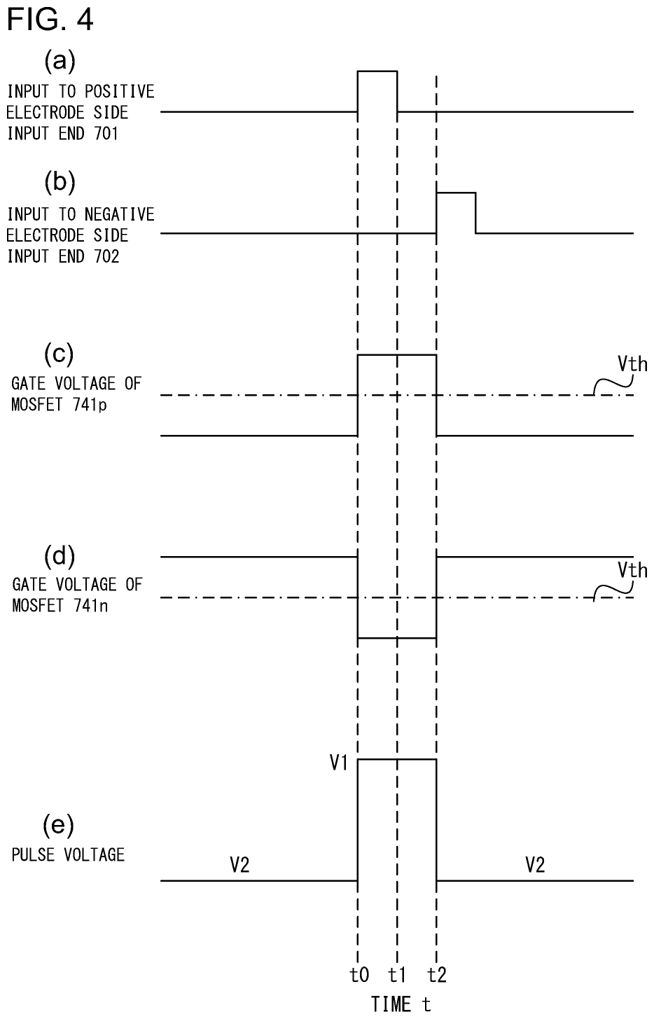

FIG. 4 is a diagram schematically showing a voltage in each part of the analytical device 1 when the pulse voltage is applied to the pusher electrode 311. (a) and (b) are input voltages to a positive electrode side input end 701 and a negative electrode side input end 702 output from the voltage control unit 510, respectively. (c) and (d) are gate voltages of MOSFETs 741p and 741n, respectively. (e) is a pulse voltage applied to the pusher electrode 311.

The gate voltage of the MOSFETs 741p is less than the threshold voltage Vth, and the gate voltage of the MOSFETs 741n is equal to or more than the threshold voltage Vth (time t<t0). At this time, the MOSFETs 741p are in an OFF-state (state in which the source and drain are not conducting), and the MOSFETs 741n are in an ON-state (state in which the source and drain are conducting). The voltage of the pusher electrode 311 is equal to the voltage V2 of the output end 705 on the negative electrode side and thus 0V. In this case, when a positive voltage pulse is input to the positive electrode side input end 701 as a control signal (t=t0), the MOSFET 711 is turned to the ON-state. The current that flows when the MOSFET 711 turns to the ON-state induces a voltage to the primary transformer 713, and the MOSFETs 715 and 716 are turned to the ON-state. The drive current is induced to the primary winding of the transformer 72 by the current that flows when both the MOSFETs 715 and 716 turn to the ON-state.

When a voltage is induced to the secondary winding of the transformer 72 by this drive current, a positive gate voltage is applied to the MOSFETs 741p via the secondary drive unit 73. As a result, electrical continuity between the positive electrode side output end 704 of the high voltage power supply unit 75 and the pulse voltage output end 703 is established, and the voltage V1=2500 [V] caused by the high voltage power supply unit 75 is applied to the pusher electrode 311. On the other hand, since a negative gate voltage is applied to the MOSFETs 741n via the secondary drive unit 73, the MOSFETs 741n are turned to the OFF-state, electrical continuity between the negative electrode side output end 705 of the high voltage power supply unit 75 and the pulse voltage output end 703 is not established.

Even if the input voltage to the positive electrode side input end 701 becomes low (t=t1) after the pulse voltage rises in this way, the ON-state of the MOSFETs 741p is maintained due to the characteristics of the secondary side drive unit 73 and the MOSFETs 741p. After the input voltage to the positive electrode side input end 701 is lowered, the voltage of the negative electrode side input end 702 corresponding to the gate voltage of the MOSFET 712 is raised by the control signal from the voltage control unit 510 (t=t2). As a result, electrical continuity between the pulse voltage output end 703 and the positive electrode side output end 704 of the high voltage power supply unit 75 is broken. On the other hand, electrical continuity between the pulse voltage output end 703 and the negative electrode side output end 705 is established, and the voltage V2=0 [V] of the negative electrode side output end 705 is again applied to the pusher electrode 311.

By the way, in the conventional analytical device, there is a problem that; when temperature of switching elements SW (MOSFETs 741p, 741n) constituting the switch unit 74 changes due to a change in ambient temperature, heat generation of the switching elements SW, or the like, the time at which application of a pulse voltage starts (hereinafter referred to as application start time), the time at which application of the pulse voltage ends (hereinafter referred to as application end time), or the waveform of the pulse voltage changes, and thereby flight time vanes.

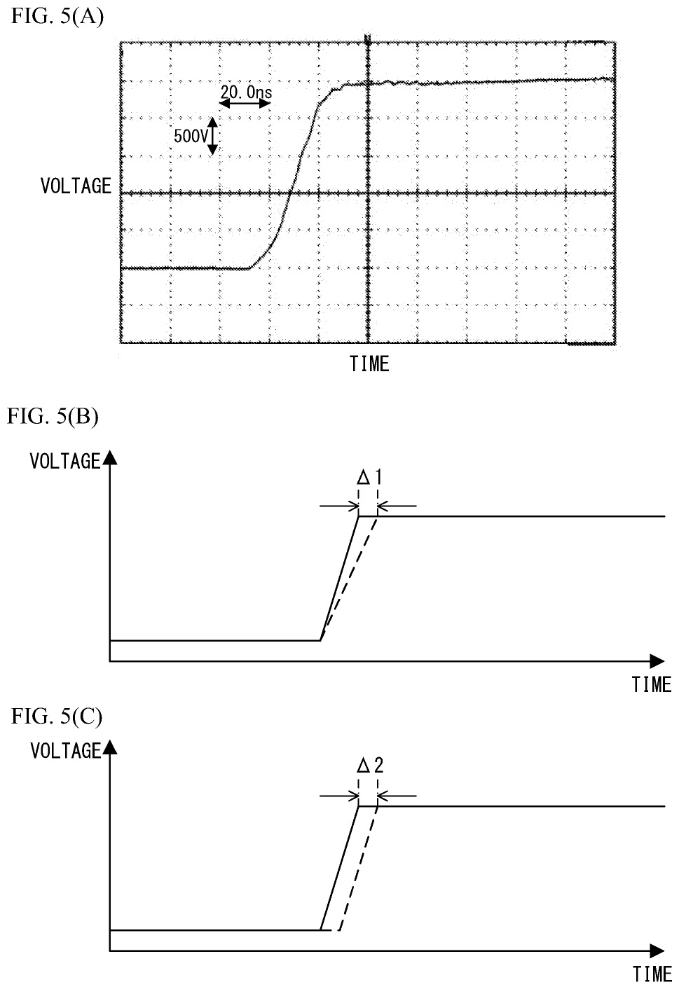

FIG. 5(A) is a graph showing an example of the waveform of a pulse voltage applied to the pusher electrode 311 at the time of output start. In this example, the wave height of the pulse voltage is around 2500V and 10% to 90% rise time is about 20 ns. Considering the case of a negative pulse voltage, in the following, the term “rising” refers to an increase in voltage, which does not necessarily mean that this voltage rising is at the leading edge of the pulse. The term “falling” refers to a drop in voltage, which does not necessarily mean that this voltage falling is at the trailing edge of the pulse. The change in voltage of the first acceleration unit 310 when starting the acceleration of ions is appropriately referred to as output start. The output start corresponds to a change in voltage at the leading edge of the pulse.

FIG. 5(B) is a graph for explaining influence on measurement of flight time due to the variation of the rise time/fall time at the time of output start. Compared with the solid line pulse waveform, the broken line pulse waveform takes a longer time for the pulse to rise. As a result, energy received by the ions being accelerated at the time of the output start varies, and therefore the speed of the ions varies, so that the flight time also varies. The variation in flight time in this case is based on the time of Δ1 in the figure at the maximum. The same can be applied to the case where the polarity of the pulse voltage is opposite in which the voltage drops at the time of the output start.

FIG. 5(C) is a graph for explaining influence on measurement of flight time due to the variation in the application start time. Compared with the solid line pulse waveform, the application start time is delayed by Δ2 in the broken line pulse waveform. As a result, the time for the ions to start accelerating varies at the time of the output start, thereby the flight time varies.

As the temperature of the switching element SW changes, the switching characteristics of the switching element SW change depending on the temperature. It causes the above-mentioned changes in the application start time, application end time, and pulse voltage waveform. For example, in a MOSFET, the speed of change in conductance between the source and the drain after the gate voltage exceeds the threshold value can change depending on the temperature, so that the application start time, application end time, and, rise time and fall time of the pulse voltage waveform will change.

The cause of the temperature change of the switching element SW is a change in the pulse frequency (repetition). In one example of TOF-MS, in the case where the pulse frequency is increased from 2 kHz to 8 kHz, the loss of MOSFET 741 (hereinafter referred to as MOSFET 741 when MOSFET 741p and 741n are not distinguished from each other) changes by around 0.2 W, and the temperature of the MOSFET 741 changes around 20° C. Due to the temperature change of 20° C., the rise time/fall time at the time of output start of the MOSFET 741 changes by around 100 ps. This 100 ps causes a variation in flight time of around 3 ppm when detecting ions having m/z 1000, which adversely affects precise mass measurement.

In addition, the temperature of the switching element SW changes due to a change in room temperature. As an example, the rise time of the MOSFET 741 changes by around 50 ps due to a change in room temperature of 10° C. This 50 ps causes a variation in flight time of about 1.5 ppm when detecting m/z 1000 ions, which adversely affects precise mass measurement.

In the analytical device 1, the switching elements SW are arranged in contact with the heat conductive portion 80, and the heat conductive portion 80 is arranged in contact with the vacuum vessel 300 constituting the vacuum partition of the analysis chamber 30. Here, “contact” means also including the case where a substance for adhesion or heat dissipation such as grease or a heat dissipation sheet intervenes between them. The heat conductive portion 80 is configured to include an insulator, and this insulator insulates the switching elements SW connected to the high voltage power supply unit 75 form the analysis chamber 30, so that the voltage of the high voltage power supply unit 75 does not adversely affect the analysis chamber 30.

The insulator included in the heat conductive portion 80 is made of a material having a predetermined thermal conductivity, and this material preferably has a thermal conductivity of 2 W/(m·K) or more at 20° C., more preferably 10 W/(m·K) or more, and further preferably 20 W/(m·K) or more. The higher the thermal conductivity, the more quickly the heat generated in the switching element SW due to the change in pulse frequency or the like can be dissipated. Since a material having a very high thermal conductivity is difficult to obtain or expensive, the thermal conductivity of the material included in the insulator of the heat conductive portion 80 is preferably 5000 W/(m·K) or less, 1000 W/(m·K) or less, or the like.

As shown in FIG. 1, it is preferable that the switching elements SW are arranged in contact with the insulator included in the heat conductive portion 80 and this insulator is arranged in contact with the vacuum vessel 300 constituting the vacuum partition of the analysis chamber 30. The type of material constituting such an insulator is not particularly limited, but ceramics such as alumina, silicon nitride, and zirconia are preferable because of their high thermal conductivity, and among them, alumina is preferable from the viewpoint of its high thermal conductivity and that it is easy to obtain and process.

As an example, assuming that the heat conductive portion 80 is an alumina block having a rectangular parallelepiped shape having a length of 15 mm, a width of 10 mm, and a thickness of 10 mm, the thermal resistance of this block is 3.33° C./W. Assuming that the thermal resistance of other heat radiating sheet and the like is 2° C./W, the combined thermal resistance is 5.33° C./W. Even if the pulse frequency changes and a loss of 0.2 W occurs as described above, the temperature rise of the MOSFET 741 is around 1° C. (5.33° C./W×0.2 W). In this case, the change in the rise/fall time at the output start of the pulse voltage is suppressed to around 5 ps, and the variation in the flight time is also suppressed to around 0.15 ppm.

The temperature regulation unit 90 includes a temperature regulator, regulates the temperature of the vacuum vessel 300 constituting the vacuum partition of the analysis chamber 30, and also regulates the temperature of the flight tube 330. The switching elements SW in the present embodiment are in contact with the heat conductive portion 80, and the heat conductive portion 80 is in contact with the temperature-regulated vacuum vessel 300. Thereby, the temperature of the switching elements SW is maintained even when the room temperature changes.

As an example, assuming that, the thermal resistance between the MOSFET 741 without a heat sink, and the outside air is 62.5° C./W and the thermal resistance between the MOSFET 741 and the vacuum vessel 300 constituting the vacuum partition of the analysis chamber 30 is 5° C./W. In this case, even if the temperature of the ambient atmosphere of the MOSFET 741 changes by 10° C., the temperature rise of the MOSFET 741 is 0.7° C.(=10° C.×5/(62.5+5)), and the variation in flight time can be suppressed to around 0.11 ppm.

Returning to FIG. 2, the information processing unit 40 includes an input unit 41, a communication unit 42, a storage unit 43, an output unit 44, and the control unit 50. The control unit 50 includes a device control unit 51, an analysis unit 52, and an output control unit 53. The device control unit 51 includes the voltage control unit 510.

The information processing unit 40 is provided with an information processing device such as a computer and serves as an interface with a user as appropriate, and also performs processing such as communication, storage, and calculation related to various data. The information processing unit 40 serves as a processing device performing processing such as control of the control unit 100, data analysis and display.

It is to be noted that, the information processing unit 40 may be configured as one device integrated with the liquid chromatograph 10 and/or the mass spectrometer 20. Further, a part of the data used by the analytical device 1 may be stored in a remote server or the like, and a part of the arithmetic processing performed by the analytical device 1 may be performed by a remote server or the like. The information processing unit 40 may control operation of each unit of the measurement unit 100, or the devices constituting each unit may control operation of each unit.

The input unit 41 of the information processing unit 40 includes an input device such as a mouse, a keyboard, various buttons, and/or a touch panel. The input unit 41 receives from the user information necessary for the measurement performed by the measurement unit 100 and the processing performed by the control unit 50.

The communication unit 42 of the information processing unit 40 includes a communication device capable of communicating by a wireless or wired connection via a network such as the internet. The communication unit 42 appropriately transmits and receives necessary data. For example, the communication unit 42 may receive data necessary for measurement by the measurement unit 100 and transmit data processed by the control unit 50 such as results of the analysis by the analysis unit 52.

The storage unit 43 of the information processing unit 40 includes a non-volatile storage medium. The storage unit 43 stores, measurement data based on the detection signal output from the detection unit 360, a program for the control unit 50 to execute processing, and the like.

The output unit 44 of the information processing unit 40 is controlled by the output control unit 53 and includes a display device such as a liquid crystal monitor, and/or a printer. The output unit 44 outputs information on the measurement of the measurement unit 100, results of the analysis of the analysis unit 52, and the like by displaying on a display device or printing on a print medium.

The control unit 50 of the information processing unit 40 includes a processor such as a CPU. The control unit 50 performs various processes by executing a program stored in the storage unit 43 or the like, such as controlling the measurement unit 100 or analyzing measurement data.

The device control unit 51 of the control unit 50 controls the measurement operation of the measurement unit 100 based on the measurement conditions and the like set according to the input and the like via the input unit 41. The device control unit 51 controls the operation of each unit of the liquid chromatograph 10 and the mass spectrometer 20.

The voltage control unit 510 outputs a control signal to the primary side drive unit 71 to control the application of the pulse voltage to the pusher electrode 311, the puller electrode 312 and the like. In the example of the present embodiment, a pulse signal is output as a control signal at a predetermined pulse frequency to the positive electrode side input end 701 and the negative electrode side input end 702.

The analysis unit 52 analyzes the measurement data. The analysis unit 52 converts the flight time of the detection signal output from the detection unit 360 into m/z based on a calibration data acquired in advance, and makes the m/z values of the detected ions correspond to detection intensity. The analysis unit 52 creates data corresponding to a mass chromatogram in which the retention time correspond to the detection intensity, and creates data corresponding to the mass spectrum in which m/z corresponds to the detection intensity. The analysis method performed by the analysis unit 52 is not particularly limited.

The output control unit 53 creates an output image including information about the measurement conditions of the measurement unit 100 or the results of the analysis by the analysis unit 52 such as the mass chromatogram or the mass spectrum, and causes the output unit 44 to output the output image.

According to the above-described embodiment, the following effects can be obtained.

(1) The analytical device 1 according to the present embodiment includes: the pusher electrode 311 or the puller electrode 312 to which a pulse voltage for accelerating ions is applied; at least one MOSFET 741 as the switching element SW that controls application of the pulse voltage to these electrodes; the flight tube electrode that defines a space in which the ions fly: the detection unit 360; and the vacuum vessel 300 that has the flight tube electrode inside, wherein: the MOSFET 741 is in contact with the heat conductive portion 80, and the heat conductive portion 80 is in contact with the vacuum vessel 300. Accordingly, even if the frequency with which the pulse voltage is applied to the pusher electrode 311 or the puller electrode 312 changes, the change in the temperature of the MOSFET 741 can be reduced, and the variation in flight time can be suppressed. Further, in order to efficiently measure ions having various m/z with different flight times, it is preferable to change the pulse frequency according to the flight time, and even in such a case, the analytical device 1 can accurately measure flight time.

(2) The analytical device 1 according to the present embodiment includes the liquid chromatograph 10. Accordingly, even when molecules having different m/z are eluted from the liquid chromatograph 10 at the same time, these molecules can be detected efficiently and accurately with an appropriate pulse frequency for each molecule.

(3) The analytical device 1 according to the present embodiment includes the temperature regulation unit 90 that regulates the temperature of the vacuum vessel 300. Accordingly, since the vacuum vessel 300, whose temperature is regulated by the temperature regulation unit 90, and the MOSFET 741 are thermally coupled, the change in the temperature of the MOSFET 741 can be reduced even if the room temperature changes, and it is possible to suppress variations in flight time.

(4) The analytical device 1 according to the present embodiment includes the mass spectrometer 20. Accordingly, it is possible to efficiently and accurately measure the flight time of ions having various m/z including high mass of several thousand Da or more.

The following Variations are also within the scope of the present invention and can be combined with the above embodiment. In the following Variations, parts showing the same structure and function as those in the above-described embodiment will be referred to by the same reference signs, and the description thereof will be omitted as appropriate.

### Variation 1

In the above-described embodiment, a metal block 302 may be arranged between the vacuum vessel 300 constituting the vacuum partition of the analysis chamber 30 and the heat conductive portion 80. The type of metal constituting the metal block 302 is not particularly limited, however a metal having a thermal conductivity of 50 W/(m·K) or more is preferable, and for example, aluminum.

In the method of attaching the switch unit 74 of the present Variation to the vacuum vessel 300 in the manufacturing method of the analytical device 1, each of the plurality of MOSFETs 741 which are the switching elements SW are attached to each of the heat conductive portions 80. The plurality of heat conductive portions 80 each of which the MOSFET 741 are attached to respectively are attached to the metal block 302 that is integrally formed. The metal block 302 on which a plurality of MOSFETs 741 are attached each via the heat conductive portion 80 is attached to the vacuum vessel 300.

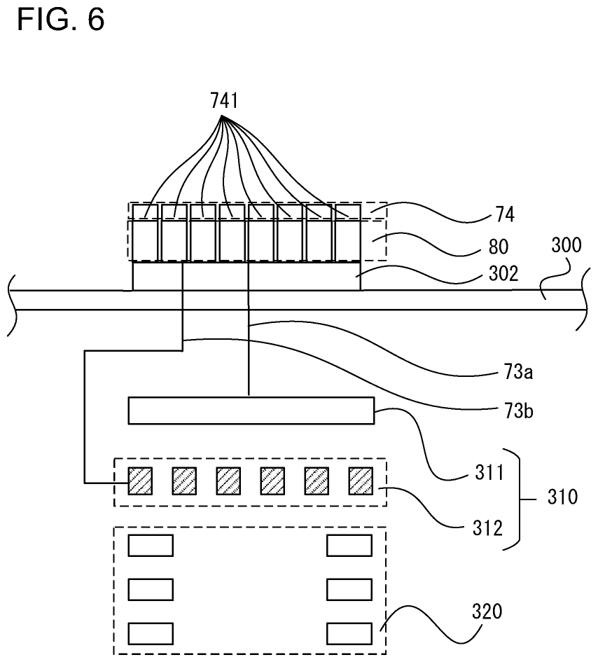

FIG. 6 is a conceptual diagram for explaining the metal block 302 that functions as a mounting portion of the switch unit 74. The switch unit 74, the heat conductive portions 80, and the metal block 302 are arranged on the outside of the vacuum vessel 300. The pusher electrode 311 and the puller electrode 312 constituting the first acceleration unit 310, and the second acceleration unit 320 are arranged inside the vacuum vessel 300. The pusher electrode 311 and the puller electrode 312 are connected to the switch unit 74 by the lead wires 73a and 73b, respectively. The vacuum vessel 300 contains a metal such as aluminum as a main component.

The metal block 302 is useful in that the height at which the MOSFET 741 is arranged can be easily adjusted. Further, the switch unit 74 includes a plurality of MOSFETs 741 arranged in series as shown in FIG. 3. Managing the plurality of MOSFETs 741 separately until they are attached to the product is cumbersome. By attaching a plurality of MOSFETs 741 to the metal block 302 together via the heat conductive portions 80 to form one component, management becomes easy and attachment to the vacuum vessel 300 is facilitated.

It is to be noted that, even in the case where the heat conductive portions 80 are attached to the vacuum vessel 300 via the metal block 302 as in the present variation, the metal block 302 and the vacuum vessel 300 are considered as one integrated vacuum vessel, and it is assumed that the heat conductive portions 80 and this vacuum vessel are in “contact” with each other.

In the analytical device 1 according to the present variation, the vacuum vessel 300 includes the metal block 302 which is a mounting portion for attaching the heat conductive portions 80, and the metal block 302 holds a plurality of MOSFETs 741 as switching elements SW via the heat conductive portions 80. Accordingly, the height of the switching elements SW can be adjusted, the management of parts including the MOSFETs 741 can be easy, and MOSFETs 741 can be easily attached to the vacuum vessel 300.

Variation 2

In the above embodiment, the heat conductive portion 80 is applied to the time-of-flight mass spectrometer 20, however it may be applied to an electric field type Fourier transform mass spectrometer. An electric field type Fourier transform mass spectrometer called the Orbitrap has an inner electrode and an outer electrode as an electrostatic trap that defines the space in which ions fly, and ions accelerated by a pulse voltage are incident between the inner electrode and the outer electrode. Therefore, the heat conductive portion 80 can be arranged so as to be in contact with both the switching element that controls application of the pulse voltage and a vacuum vessel that constitutes the vacuum partition of the Fourier transform mass spectrometer.

Further, although the analytical device 1 of the above-described embodiment is a liquid chromatograph-tandem mass spectrometer, the liquid chromatograph may not be equipped, and a separation analytical device other than the liquid chromatograph may be equipped. The mass spectrometer 20 may be a TOF-MS that is not a tandem mass spectrometer.

Variation 3

In the above-described embodiment, a case where a MOSFET is used as a switching element has been described as an example, however the type of the switching element is not particularly limited as long as the switching characteristics change due to a temperature change. The present invention can be applied to various cases, for example, such as an IGBT (Insulated Gate Bipolar Transistor). Further, the circuit configuration of the pulse voltage application circuit 70 is not limited to that shown in FIG. 3, and the present invention can be applied to various circuits in which a pulse voltage is applied by using a switching element.

The present invention is not limited to the contents of the above embodiments. Other modes that are conceivable within the scope of the technical idea of the present invention are also included within the scope of the present invention.

### REFERENCE SIGNS LIST

1 . . . Analytical Device,
10 . . . Liquid Chromatograph,
14 . . . Analytical Column,
20 . . . Mass Spectrometer,
21 . . . Ionization Chamber,
23 . . . First Mass Separation Unit,
24 . . . Collision Cell,
30 . . . Analysis Chamber,
40 . . . Information Processing Unit,
50 . . . Control Unit,
51 . . . Device Control Unit,
52 . . . Analysis Unit,
53 . . . Output Control Unit,
70 . . . Pulse Voltage Application Circuit,
71 . . . Primary Side Drive Unit,
72 . . . Transformer,
73 . . . Secondary Side Drive Unit,
74 . . . Switch Unit,
75 . . . High Voltage Power Supply Unit,
80 . . . Heat Conductive Portion,
90 . . . Temperature Regulation Unit,
100 . . . Measurement Unit,
300 . . . Vacuum Vessel,
302 . . . Metal Block,
310 . . . First Acceleration Unit,
311 . . . Pusher Electrode,
312 . . . Puller Electrode,
320 . . . Second Acceleration Unit,
330 . . . Flight Tube,
340 . . . Reflectron Electrode,
360 . . . Detection Unit,
741, 741p, 741n . . . MOSFET,
S . . . Sample.

1. An analytical method of performing time-of-flight mass spectrometry using a vacuum vessel that includes a first electrode, an ion detector and a flight space, including:
applying a pulse voltage for accelerating ions toward the flight space to the first electrode;
controlling application of the pulse voltage to the first electrode using at least one switching element;
detecting the ions that have flown in the flight space using the ion detector; and
maintaining a temperature of the switching element even in a case in which a room temperature changes by regulating a temperature of the vacuum vessel thermally coupled to the switching element via the insulator.

2. The analytical method according to claim 1, wherein
thermal conductivity of the insulator at 20° C. is 2 W/(m·K) or more.

3. The analytical method according to claim 2, wherein
the insulator comprises ceramics.

4. The analytical method according to claim 3, wherein
the insulator comprises alumina.

5. The analytical method according to claim 1, wherein
the vacuum vessel includes a mounting portion for mounting the insulator, and
the mounting portion holds the at least one switching element via the insulator.

6. The analytical method according to claim 2, wherein
the vacuum vessel includes a mounting portion for mounting the insulator, and
the mounting portion holds the at least one switching element via the insulator.

7. The analytical method according to claim 3, wherein
the vacuum vessel includes a mounting portion for mounting the insulator, and
the mounting portion holds the at least one switching element via the insulator.

8. The analytical method according to claim 4, wherein
the vacuum vessel includes a mounting portion for mounting the insulator, and
the mounting portion holds the at least one switching element via the insulator.

9. The analytical method according to claim 5, wherein
the vacuum vessel includes a mounting portion for mounting the insulator, and
the mounting portion holds the at least one switching element via the insulator.

10. The analytical method according to claim 6, wherein
the vacuum vessel includes a mounting portion for mounting the insulator, and
the mounting portion holds the at least one switching element via the insulator.

11. The analytical method according to claim 7, wherein
the vacuum vessel includes a mounting portion for mounting the insulator, and
the mounting portion holds the at least one switching element via the insulator.

12. The analytical method according to claim 8, wherein
the vacuum vessel includes a mounting portion for mounting the insulator, and
the mounting portion holds the at least one switching element via the insulator.

13. The analytical method according to claim 1, wherein
at least one of time-of-flight mass spectrometry and electric field type Fourier transform mass spectrometry is performed.
